(19) United States
(12) Patent Application Publication
(10) Pub. No.: US 2009/0021628 A1
(43) Pub. Date: Jan. 22, 2009

(54) CCD SOLID-STATE IMAGING DEVICE, DRIVE METHOD THEREOF AND IMAGING APPARATUS

(76) Inventor: Akira TAMAKOSHI, Kurokawa-gun (JP)

Correspondence Address: BIRCH STEWART KOLASCH & BIRCH, PO BOX 747, FALLS CHURCH, VA, 22040-0747, US

(21) Appl. No.: 12/168,631

(22) Filed: Jul. 7, 2008

(30) Foreign Application Priority Data
Jul. 9, 2007 (JP) P2007-179733

(51) Int. Cl. H04N 3/14

(52) U.S. Cl. 348/311; 348/E03.016

(57) ABSTRACT

In a CCD solid-state imaging device that transfers, in an output charge transfer path, a first charge detected in a pixel of an effective pixel area and a second charge detected in a pixel of an optical black portion adjacent to the effective pixel area, and outputs the first and second charges, a charge transfer speed of the second charge is made lower than that of the first charge whenever the second charge is transferred in the output charge transfer path and is output.

This application is based on and claims priority under 35 U.S.C. § 119 from Japanese Patent Application No. 2007-179733 filed Jul. 9, 2007, the entire disclosure of which is herein incorporated by reference.

### BACKGROUND OF THE INVENTION

1. Field of the Invention

This invention relates to a CCD (Charge Coupled Device) solid-state imaging device, a drive method thereof, and an imaging apparatus and in particular to a CCD solid-state imaging device, a drive method thereof, and an imaging apparatus, which make it possible to reduce the number of pixels in each optical black (OB) portion provided surrounding an effective pixel area to detect a black level signal.

2. Description of Related Art

FIG. 7 is a surface schematic drawing of a CCD solid-state imaging device. Optical black (OB) portions 3 are provided surrounding and adjacent to an effective pixel area 2 of a CCD solid-state imaging device 1, a horizontal charge transfer path (HCCD) 4 as an output charge transfer path is provided in a lower side portion, and an amplifier 5 for outputting a voltage value signal (output signal OS) in accordance with the charge amount of transferred signal charge is provided in the output end part of the horizontal charge transfer path 4.

The OB portions 3 are provided so as to surround the effective pixel area 2, but the OB portions above and below the effective pixel area 2 are not shown in FIG. 7.

FIG. 8 is a detailed schematic drawing of FIG. 7. Each of the effective pixel area 2 and the OB portions 3 is formed with a two-dimensional array of photoelectric conversion elements (pixels) 6. In the example shown in the figure, a vertical charge transfer path (VCCD) 7 is provided at the left of each photoelectric conversion element column.

Each pixel 6 of the OB portion 3 is covered with a light shield film and a detection signal of the pixel 6 of the OB portion 3 is transferred in the vertical charge transfer path 7 and the horizontal charge transfer path 4 in a horizontal blanking period and a vertical blanking period and is output, whereby a “black” level signal is detected.

FIG. 9 is a drive timing chart of the CCD solid-state imaging device shown in FIG. 7. The horizontal charge transfer path (HCCD) 4 transfers a signal charge to the amplifier 5 according to two-phase transfer pulses H1 and H2 and the signal charge as a result of reading a voltage value signal in accordance with the charge amount by the amplifier 5 is discarded according to a reset pulse RS.

Consequently, the signal obtained from the CCD solid-state imaging device as an output signal OS becomes a repetition of a reset period a, a feed through period b, and a signal period c. The signal level in the signal period c is shown in the figure as a constant level; in fact, however, the signal level moves up or down in response to the light reception amount as indicated by a vertical double-head arrow.

When the signal charge of one row of the pixels 6 of the effective pixel area 2 is transferred along the horizontal charge transfer path and is output, the signal level in the signal period c becomes a signal in accordance with the light reception amount. In contrast, in the signal level in the signal period c during output of the OB portion 3 (black level), the dark current component depending on the temperature etc., of the CCD solid-state imaging device at that time becomes dominant and the black level is subtracted from the output signal level in the effective pixel area 2, whereby it is made possible to provide a signal whose dark current noise is canceled.

To detect a black level signal, the CCD solid-state imaging device requires the time for outputting the signal level in the OB portion 3 and performing signal processing. Then, in a related art, for example, at the pixel thinning read time such as the time of shooting moving image, etc., the pixel thinning read speed in the OB portion is decreased for ensuring the required time.

The related art described above relates to drive speed control of the CCD solid-state imaging device at the pixel thinning time and is intended for avoiding the situation in which the output time in the OB portion becomes short at the pixel thinning time. Thus, the CCD solid-state imaging device is designed on the precondition that signal charge is read from all pixels at the usual photographing time.

In recent years, the number of pixels mounted on a CCD solid-state imaging device has ever grown and a digital camera having over 10,000,000 pixels also has become widespread. Making a comparison between a CCD solid-state imaging device having 300,000 pixels and a CCD solid-state imaging device having 10,000,000 pixels, it becomes necessary to make high the drive frequency (transfer frequency) of the CCD solid-state imaging device having 10,000,000 pixels to control the time reading the signal charge of the pixels making up one screen in the same manner.

However, the number of pixels in the OB portion per horizontal scanning, “k,” is determined by the pixel read time in the OB portion or the length of the horizontal blanking period, the vertical blanking period. Letting the horizontal transfer frequency be “fH,” the pixel read time in the OB portion becomes k/fH and thus if fH is made high, it becomes impossible to ensure the pixel read time in the OB portion and it becomes impossible to provide a stable black level signal.

Then, the number of pixels in the OB portion, k, is increased in proportion to the higher drive frequency. To do this, it becomes necessary to increase the chip area of the CCD solid-state imaging device and the manufacturing cost increases. It becomes impossible to ensure the required length of the horizontal blanking period, the vertical blanking period; this is also a problem.

### SUMMARY OF THE INVENTION

An object of the invention is to provide a CCD solid-state imaging device, a drive method thereof, and an imaging apparatus, which make it possible to ensure the pixel signal read time in an OB portion and ensure the required length of a horizontal blanking period, a vertical blanking period without increasing the pixel area of the OB portion if the horizontal transfer frequency is increased.

According to an aspect of the invention, there is provided a method for driving a CCD solid-state imaging device that transfers, in an output charge transfer path, a first charge detected in a pixel of an effective pixel area and a second charge detected in a pixel of an optical black portion adjacent to the effective pixel area, and outputs the first and second charges. The method includes making a charge transfer speed of the second charge lower than that of the first charge whenever the second charge is transferred in the output charge transfer path and is output.

In the method, when the charge transfer speed of the second charge is made lower, an operation speed of a correlated double sampling processing circuit at a later stage of the CCD solid-state imaging device may be made lower.

In the method, the charge transfer speed of the second charge may be made lower while a phase shift of a pulse edge and a duty ratio with respect to a control signal for transferring and outputting the first and second charges are kept constant.

In the method, the charge transfer speed of the second charge may be made lower by a frequency dividing circuit.

In the method, the frequency dividing circuit may be driven in accordance with a reference clock having a frequency a specific number of times higher than a transfer frequency of the output charge transfer path.

In the method, a frequency dividing number of the frequency dividing circuit may be variably set.

According to another aspect of the invention, there is provided a CCD solid-state imaging device that is driven according to the above, in which the number of pixels in the optical black portion is decreased as much as the charge transfer speed of the second charge is made lower, so that an output time of the second charge is substantially same as an output time if the charge transfer speed of the second charge is not made lower and the number of the pixels in the optical black portion is not decreased.

According to still another aspect of the invention, there is provided an imaging apparatus including: a CCD solid-state imaging device that transfers, in an output charge transfer path, a first charge detected in a pixel of an effective pixel area and a second charge detected in a pixel of an optical black portion adjacent to the effective pixel area, and outputs the first and second charges; and a drive section that drives the CCD solid-state imaging device so as to make a charge transfer speed of the second charge lower than that of the first charge whenever the second charge is transferred in the output charge transfer path and is output.

In the imaging apparatus, the drive section may make lower an operation speed of a correlated double sampling processing circuit at a later stage of the CCD solid-state imaging device when the charge transfer speed of the second charge is made lower.

In the imaging apparatus, the drive section may make the charge transfer speed of the second charge lower while a phase shift of a pulse edge and a duty ratio with respect to a control signal for transferring and outputting the first and second charges are kept constant.

In the imaging apparatus, the drive section may include a frequency dividing circuit, and the charge transfer speed of the second charge is made lower by a frequency dividing circuit.

In the imaging apparatus, the drive section may drive the frequency dividing circuit in accordance with a reference clock having a frequency a specific number of times higher than a transfer frequency of the output charge transfer path.

In the imaging apparatus, the drive section may include a section that variably sets a frequency dividing number of the frequency dividing circuit.

### BRIEF DESCRIPTION OF THE DRAWINGS

The features of the invention will appear more fully upon consideration of the exemplary embodiments of the inventions, which are schematically set forth in the drawings, in which:

FIG. 1 is a functional block diagram of a digital camera according to a first exemplary embodiment of the invention;

FIG. 2 is a diagram to show the configuration of a CDS circuit contained in an analog signal processing circuit in FIG. 1;

FIG. 3 is a main part configuration drawing of a drive section shown in FIG. 1;

FIG. 4 is a timing chart of various signals shown in FIG. 3;

FIG. 5 is a main part configuration drawing of a drive section according to a second exemplary embodiment of the invention;

FIG. 6 is a timing chart of various signals in the drive section shown in FIG. 5;

FIG. 7 is a surface schematic drawing of a CCD solid-state imaging device;

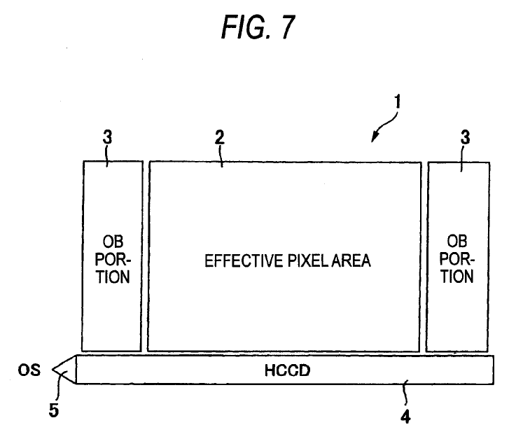

FIG. 8 is a detailed schematic drawing of FIG. 7; and

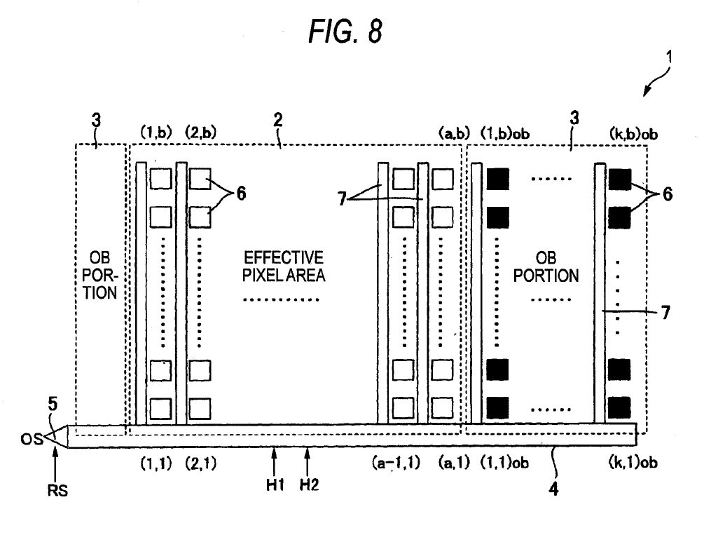

FIG. 9 is a drive signal timing chart of the CCD solid-state imaging device in a related art,

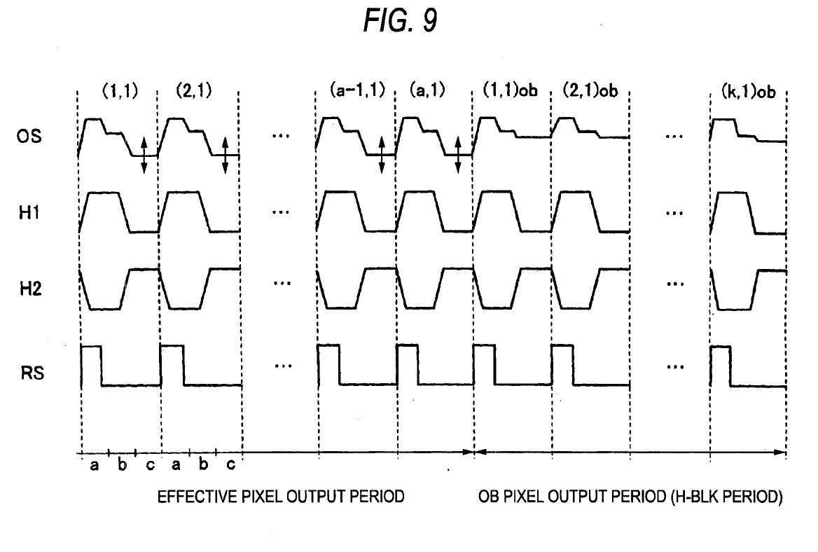

wherein description of reference numerals and signs in the drawings are set forth below.
1 CCD solid-state imaging device
2 Effective pixel area
3 OB (optical black) portion
4 Horizontal charge transfer path (HCCD)
5 Output amplifier
21 Imaging section
22 Analog signal processing section
24 Drive section
29 System control section
33 Operation section
52, 53, 54 Sample and hold circuit
55 Differential amplifier
61 Timing generator
62-65 Frequency dividing circuit
62a-65a Change-over switch

### DETAILED DESCRIPTION OF THE EXEMPLARY EMBODIMENTS

According to an exemplary embodiment of the invention, the number of the pixels of the optical black portion can be decreased for making the area of the optical black portion smaller and moreover it is made possible to ensure the required length of the horizontal blanking period, the vertical blanking period.

Referring now to the accompanying drawing, there are shown exemplary embodiments of the invention.

### First Embodiment

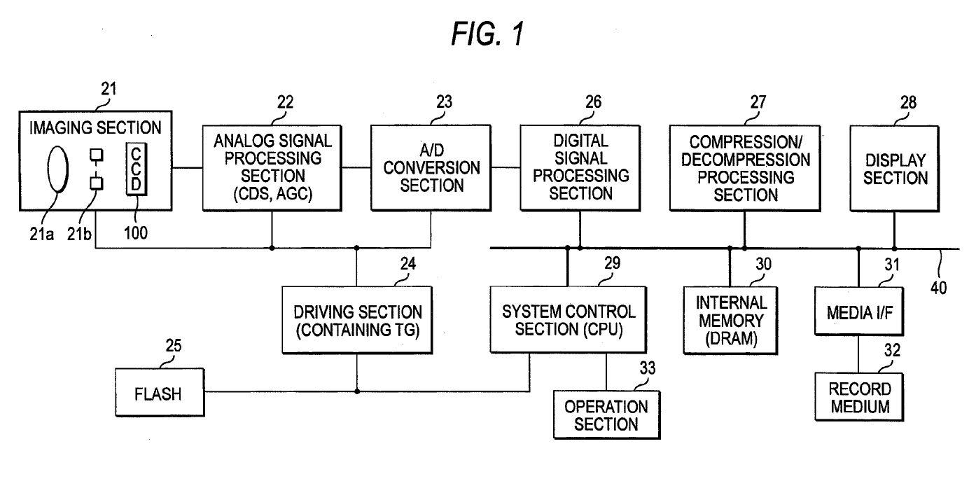

FIG. 1 is a functional block diagram of a digital camera according to a first embodiment of the invention. The digital camera includes an imaging section 21, an analog signal processing section 22 for performing analog processing of automatic gain control (AGC), correlated double sampling processing (CDS), etc., of analog image data output from the imaging section 21, an analog-digital conversion section (A/D) 23 for converting the analog image data output from the analog signal processing section 22 into digital image data, a drive section (containing a timing generator TG) 24 for performing drive control of the A/D 23, the analog signal processing section 22, and the imaging section 21 according to a command from a system control section (CPU) 29 described later, and a flash 25 for emitting light according to a command from the CPU 29.

The imaging section 21 includes an optical lens system 21a for gathering light from a subject field, a diaphragm and mechanical shutter 21b for narrowing down the light passing through the optical lens system 21a, and a CCD solid-state imaging device 100 for receiving the light gathered by the optical lens system 21a and narrowed down through the diaphragm and outputting picked-up image data (analog image data).

The digital camera of the embodiment further includes a digital signal processing section 26 for inputting the digital image data output from the A/D 23 and performing interpolation processing, white balance correction, RGB/YC conversion processing, etc., a compression/decompression processing section 27 for compressing image data to image data in a JPEG format, etc., and decompressing compressed image data, a display section 28 for displaying a menu, etc., and displaying a through image and a picked-up image, the above-mentioned system control section (CPU) 29 for controlling the whole digital camera, internal memory 30 of frame memory, etc., a media interface (I/F) section 31 for performing interface processing with a record medium 32 for storing JPEG image data, etc., and a bus 40 for connecting them. An operation section 33 for the user to enter a command is connected to the system control section 29.

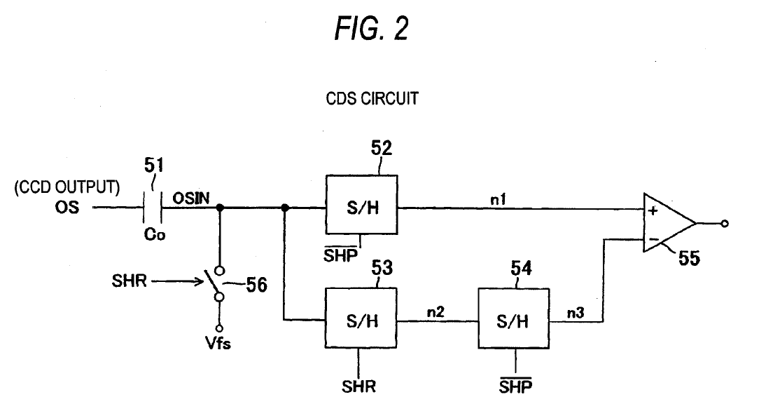

FIG. 2 is a circuit diagram of a correlated double sampling (CDS) circuit provided in the analog signal processing section 22 in FIG. 1. The CDS circuit includes a coupling capacitor (Co) 51 connected to output of the CCD solid-state imaging device 100, first and second sample and hold circuits 52 and 53 for inputting output of the coupling capacitor 51 in parallel, a third sample and hold circuit 54 connected to output of the second sample and hold circuit 53, an amplifier 55 for amplifying the difference between outputs of the first and third sample and hold circuits 52 and 54, and a switch 56 for applying a constant voltage Vfs to the input stages of the first and second sample and hold circuits 52 and 53 and clamping in a feed through period.

The switch 56 is opened and closed in accordance with a control signal SHR (closed in the feed through period), a control signal SHR bar (inversion signal of SHP signal (signal which goes low in a data output period)), a control signal SHR is applied to the sample and hold circuit 53, and a control signal SHR bar is applied to the sample and hold circuit 54. Each of the sample and hold circuits 52, 53, and 54 holds a signal at the same level as the input signal when the control signal is high, and outputs the signal.

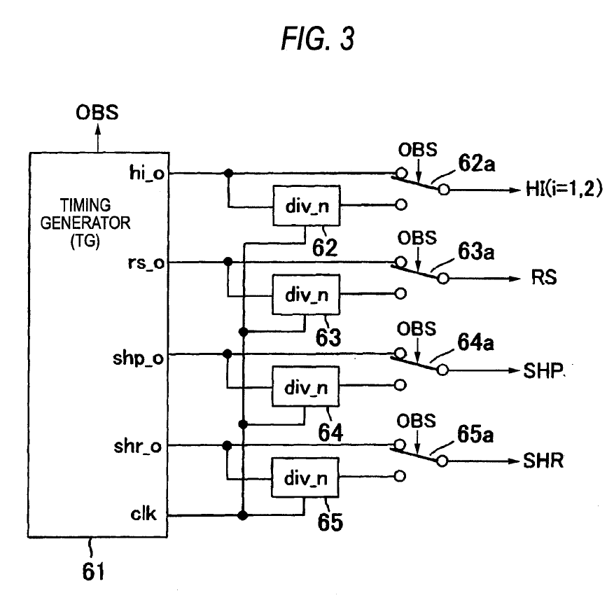

FIG. 3 is a main part configuration drawing of the drive section 24 shown in FIG. 1. The drive section 24 includes a timing generator (TG) 61, four frequency dividing circuits 62, 63, 64, and 65 and change-over switches 62a, 63a, 64a, and 65a provided in a one-to-one correspondence with the frequency dividing circuits.

The timing generator 61 outputs a signal hi_o (o=1, 2) on which horizontal transfer pulses H1 and H2 are based, a signal rs_o (o=1, 2) on which a reset pulse RS applied to the output stage of a horizontal charge transfer path (HCCD) 4 is based, a signal shp_o (o=1, 2) on which a control signal SHP is based, a signal shr_o (o=1, 2) on which a control signal SHR is based, a clock signal elk, and a control signal OBS.

The clock signal elk of the timing generator 61 is supplied to each of the frequency dividing circuits 62, 63, 64, and 65 for operation. The switch 62a switches between the output signal hi_o of the timing generator 61 and an output signal of the frequency dividing circuit 62 dividing the signal hi_o based on the control signal OBS and outputs the horizontal transfer pulse H1, H2.

The switch 63a switches between the output signal rs_o of the timing generator 61 and an output signal of the frequency dividing circuit 63 dividing the signal rs_o based on the control signal OBS and outputs the reset signal RS.

The switch 64a switches between the output signal shp_o of the timing generator 61 and an output signal of the frequency dividing circuit 64 dividing the signal shp_o based on the control signal OBS and outputs the control signal SHP.

The switch 65a switches between the output signal shr_o of the timing generator 61 and an output signal of the frequency dividing circuit 65 dividing the signal shr_o based on the control signal OBS and outputs the control signal SHR.

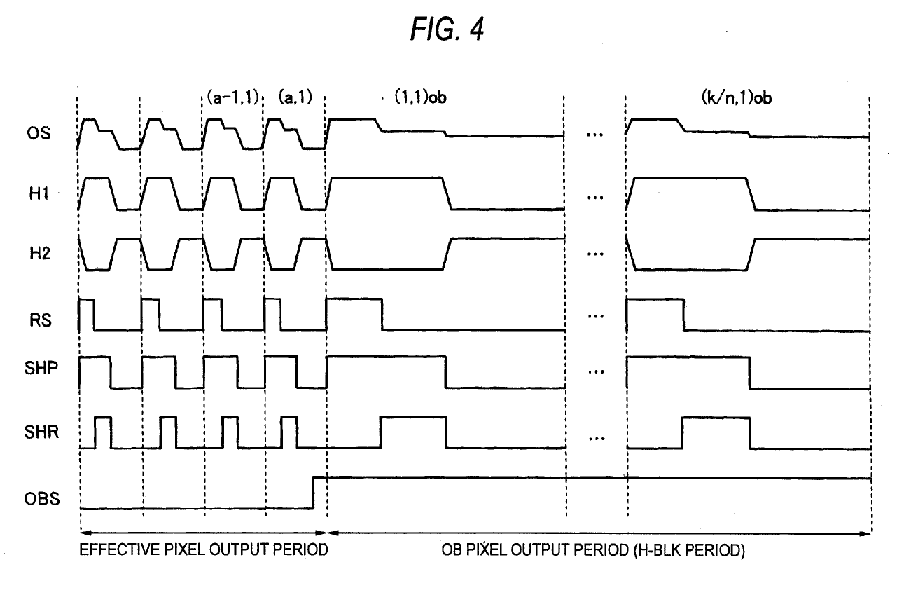

FIG. 4 is a timing chart to show an output signal OS of the CCD solid-state imaging device 100 and the signals H1, H2, RS, SHP, SHR, and OBS output from the drive section 24.

The OBS signal is a signal which goes low when the charge output from the horizontal charge transfer path is a charge read from an effective pixel area; a signal which goes high when the charge output from the horizontal charge transfer path is a charge read from an OB portion.

The switches 62a, 63a, 64a, and 65a are switched and driven according to the OSB signal. When the OSB signal is low (during signal output in an effective pixel area), the switches output the output signals hi_o, rs_o, shp_o, and shr_o of the timing generator 61 to the CCD solid-state imaging device 100 and the CDS circuit at the following stage; when the OSB signal goes high (during OB portion scanning), each switch outputs a signal provided by dividing the corresponding signal by a specific value by the corresponding frequency dividing circuit 62 to 65 to the CCD solid-state imaging device 100 and the CDS circuit at the following stage.

In the imaging apparatus including the CCD solid-state imaging device 100 and the drive section 24, the output signal OS of the CCD solid-state imaging device 100 is input to the first and second sample and hold circuits 52 and 53 and the first sample and hold circuit 52 outputs the OS signal with the control signal SHP low (in a data output period) to the amplifier 55.

The second sample and hold circuit 53 holds the signal level in a feed through period in which the control signal SHR goes high and outputs (in the feed through period, the switch 56 is closed and the constant voltage Vfs is clamped at the input stage of the sample and hold circuit 53). The third sample and hold circuit 54 outputs the signal level in the feed through period to the amplifier 55.

The differential amplifier 55 inputs the output signals of both the sample and hold circuits 52 and 54, amplifies the level difference between the output signals (the difference between the potential and the signal potential in the feed through period), and outputs it to the following circuit. Accordingly, a signal from which reset noise, etc., contained in the output signal OS of the CCD solid-state imaging device 100 is removed is provided.

In the CDS circuit and the CCD solid-state imaging device 100 operating in such a manner, in the embodiment, the drive frequency of the horizontal charge transfer path for outputting the OS signal from the CCD solid-state imaging device 100 becomes low speed when the charge output period of the OB portion (the control signal OBS is high) is entered.

For example if each of the frequency dividing circuits 62 to 65 shown in FIG. 3 is set so as to divide each input signal by four in synchronization with the clock of the timing generator 61, the charge output speed of the OB portion is decreased to a quarter as compared with the charge output speed of the effective pixel area. Accordingly, the signal read speed from the CCD solid-state imaging device 100 becomes a quarter and at the same time, the operation speed of the CDS circuit for processing the signal also becomes a quarter.

Each of the frequency dividing circuits 62 to 65 generally divides each signal hi_o, rs_o, shp_o, shr_o of the timing generator 61 by n (in the example, four) according to the reference clock elk and outputs the signal. Since the reference clock elk is set to a given frequency sufficiently higher than a horizontal transfer frequency fH (about several times fr), the frequency dividing operation can be performed in a state in which a phase shift of the rising edge, the falling edge of each signal and duty ratio are kept constant, and it is made possible to prevent a timing shift at the OB portion reading time.

In the embodiment, output of each frequency dividing circuit is selected by switching of the switch with the reference clock clk kept constant, so that stable frequency switching can be performed, malfunction of the CCD solid-state imaging device can be avoided, and highly reliable driving can be accomplished.

At the driving time of reading a black level from the CCD solid-state imaging device 100, the imaging apparatus of the embodiment is always set so as to decrease the read speed of the OB portion to 1/n as compared with the charge read speed of the effective pixel area.

Thus, for example, if the number of pixels of the OB portion required in a CCD solid-state imaging device having 10000000 effective pixels (the number of pixels of the OB portion in one horizontal direction) is 1000 (k=1000), the read speed of the OB portion is decreased to 1/n in the embodiment and thus the required number of pixels of the OB portion becomes k/n=1000/n. To divide the signal frequency by four, 1000/4=250.

However, the black level read time from the OB portion becomes (k/n)·(n/fH)=k/fH and becomes the read time independent of the speed decrease (the frequency dividing number). That is, the time required for detecting a black level is ensured and moreover it is made possible to make small the chip area to manufacture the CCD solid-state imaging device 100.

### Second Embodiment

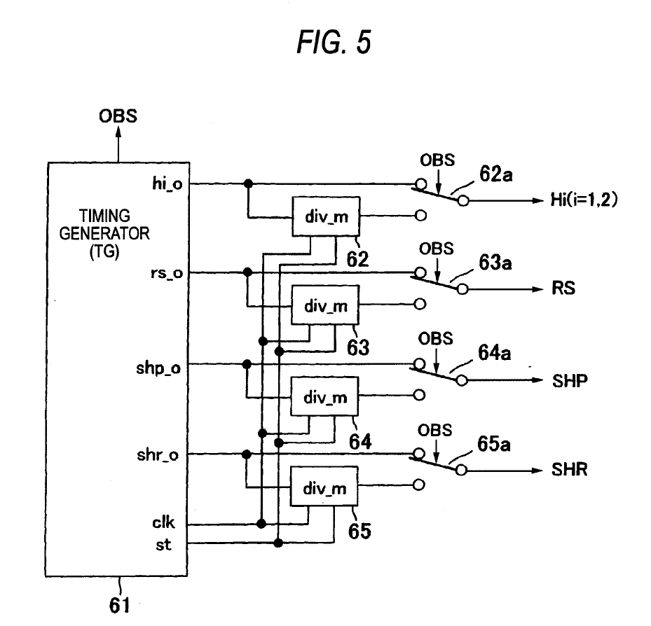

FIG. 5 is a main part configuration drawing of a drive section of an imaging apparatus according to a second embodiment of the invention. The second embodiment differs from the first embodiment shown in FIG. 3 in that any desired frequency dividing number can be set in each of frequency dividing circuits 62 to 65 a timing generator 61 includes a variable set signal output terminal st of the frequency dividing number, and the frequency dividing number of each of the frequency dividing circuits 62 to 65 is set according to the variable set signal.

As a frequency dividing number m set and output from the timing generator 613 when the user specifies a frequency dividing number through the operation section 33 in FIG. 1, for example, the frequency dividing number m based on the specification is sent through a CPU 29 to a drive section 24.

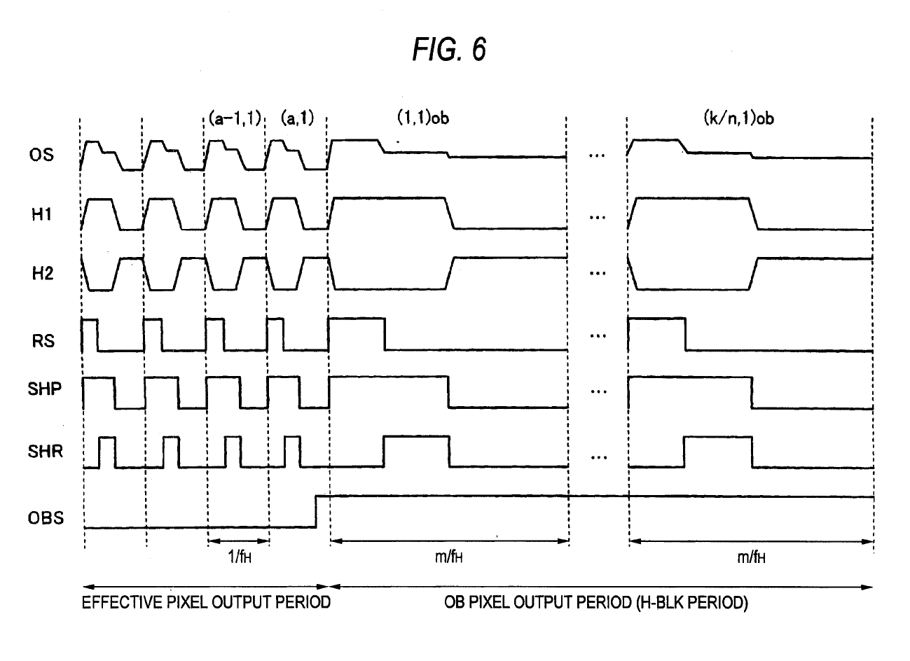

FIG. 6 is a timing chart in the embodiment; basically it is the same as the timing chart of FIG. 4 except for the frequency dividing number (speed) in the output period of an OB portion.

Once a CCD solid-state imaging device 100 is manufactured, the number of pixels of the OB portion cannot be changed. Thus, in the second embodiment, the basic frequency dividing number is set to “n.” Accordingly, the number of pixels of the OB portion can be decreased to “k/n” as compared with the related art, as with the first embodiment.

The output time per pixel in an effective pixel area is 1/fH. In the first embodiment, the output time per pixel is multiplied by n; in the second embodiment, the output time per pixel is multiplied by m as the frequency dividing number m is made variable.

Accordingly, the OB portion read time in the embodiment becomes (k/n)·(m/f)=(k·m)/(n·fH). That is, the frequency dividing number m is changed, whereby any desired OB pixel read time can be obtained and it is made possible to set the ratio between the output period of the effective pixel area and that of the OB portion as desired and it is made possible to provide an image in accordance with a television signal system by one CCD solid-state imaging device.

For example, it is made possible to pick up an image displayed on a screen with an aspect ratio 4:3 by the CCD solid-state imaging device 100 and pick up an image displayed on a screen with an aspect ratio 16:9 by the same CCD solid-state imaging device 100. Therefore, preferably the user specifies the frequency dividing number m through the operation section 33 based on the aspect ratio of the display screen.

The drive method of the CCD solid-state imaging device according to the invention has the advantage that the area of each OB portion in the solid-state imaging device intended for a larger number of pixels can be made smaller and it is made possible to install the low-cost, small-area solid-state imaging device in a digital camera, etc., by applying it to a digital camera, etc.

What is claimed is:

1. A method for driving a CCD solid-state imaging device that transfers, in an output charge transfer path, a first charge detected in a pixel of an effective pixel area and a second charge detected in a pixel of an optical black portion adjacent to the effective pixel area, and outputs the first and second charges,
the method comprising making a charge transfer speed of the second charge lower than that of the first charge whenever the second charge is transferred in the output charge transfer path and is output.

2. The method according to claim 1, wherein when the charge transfer speed of the second charge is made lower, an operation speed of a correlated double sampling processing circuit at a later stage of the CCD solid-state imaging device is made lower.

3. The method according to claim 2, wherein the charge transfer speed of the second charge is made lower while a phase shift of a pulse edge and a duty ratio with respect to a control signal for transferring and outputting the first and second charges are kept constant.

4. The method according to claim 1, wherein the charge transfer speed of the second charge is made lower by a frequency dividing circuit.

5. The method according to claim 4, wherein the frequency dividing circuit is driven in accordance with a reference clock having a frequency a specific number of times higher than a transfer frequency of the output charge transfer path.

6. The method according to claim 4, wherein a frequency dividing number of the frequency dividing circuit is variably set.

7. A CCD solid-state imaging device that is driven according to a method of claim 1, wherein the number of pixels in the optical black portion is decreased as much as the charge transfer speed of the second charge is made lower, so that an output time of the second charge is substantially same as an output time if the charge transfer speed of the second charge is not made lower and the number of the pixels in the optical black portion is not decreased.

8. An imaging apparatus comprising:
a CCD solid-state imaging device that transfers, in an output charge transfer path, a first charge detected in a pixel of an effective pixel area and a second charge detected in a pixel of an optical black portion adjacent to the effective pixel area, and outputs the first and second charges; and
a drive section that drives the CCD solid-state imaging device so as to make a charge transfer speed of the second charge lower than that of the first charge whenever the second charge is transferred in the output charge transfer path and is output.

9. The imaging apparatus according to claim 8, wherein the drive section makes lower an operation speed of a correlated double sampling processing circuit at a later stage of the CCD solid-state imaging device when the charge transfer speed of the second charge is made lower.

10. The imaging apparatus according to claim 8, wherein the drive section makes the charge transfer speed of the second charge lower while a phase shift of a pulse edge and a duty ratio with respect to a control signal for transferring and outputting the first and second charges are kept constant.

11. The imaging apparatus according to claim 10, wherein the drive section includes a frequency dividing circuit, and the charge transfer speed of the second charge is made lower by a frequency dividing circuit.

12. The imaging apparatus according to claim 11, wherein the drive section drives the frequency dividing circuit in accordance with a reference clock having a frequency a specific number of times higher than a transfer frequency of the output charge transfer path.

13. The imaging apparatus according to claim 11, wherein the drive section includes a section that variably sets a frequency dividing number of the frequency dividing circuit.
